(19) United States
(12) Patent Application Publication
(10) Pub. No.: US 2019/0064003 A1
(43) Pub. Date: Feb. 28, 2019

(54) Multipoint Temperature Profiling and Monitoring System for Composite Repair

(71) Applicant: TE Wire & Cable LLC, Saddle Brook, NJ (US)

(72) Inventors: Volodymyr Fedorchak, Mount Tabor, NJ (US); Robert M. Canny, Saddle Brook, NJ (US); Gregory J. Smith, Old Saybrook, CT (US); Mark Peters, Midland Park, NJ (US)

(21) Appl. No.: 16/115,857

(22) Filed: Aug. 29, 2018

Related U.S. Application Data
(60) Provisional application No. 62/551,626, filed on Aug. 29, 2017.

(51) Int. Cl. G01K 3/14; G01K 11/32; G01K 7/02; G01K 1/14; B23P 6/00; B64F 5/60; B64F 5/40; B29C 73/12; B29C 70/44; B32B 27/08; B32B 27/12; B32B 27/32

(52) U.S. Cl. CPC G01K 3/14; B29L 2031/3082; G01K 7/02; G01K 1/14; B23P 6/00; B64F 5/60; B64F 5/40; B29C 73/12; B29C 70/44; B32B 27/08; B32B 27/12; B32B 27/322; G01K 2003/145; G01K 2213/00; G01K 11/32

(57) ABSTRACT

A sensing system that will accurately monitor cold and hot spots and verify the appropriate area temperature for composite structure repair and where IR LED is being activated. Various embodiments of this invention may include: miniaturized thermocouples that can be embedded into the sensing system, distributed temperature sensing (DTS) system and software for heat modeling, and/or printed thermocouple circuits on thermo pads. The sensing system may be a grid of sensors that is either a standalone layer, such as a sheet or blanket, or integrated with any of the layers already common in composite repair, i.e. printed circuitry or over-molded circuitry. Additionally, the sensing system generates the temperature profile of a heated area during a fuselage repair and pin-points and identifies hot and cold problem areas on a complex fuselage section.

This application claims priority to Provisional Application, U.S. Ser. No. 62/551,626, filed Aug. 29, 2017, which is incorporated herein by reference in its entirety.

### FIELD OF INVENTION

The field of invention for this disclosure relates to a system to provide multizone or multipoint temperature monitoring and temperature measurement for composite repair and a manufacturing process of the same.

### BACKGROUND

For in-field composite fuselage repair, hot bonders and thermocouples are used for process control which control and monitor temperature and draw vacuum for the repair process. The quality of a repair can, in many cases, be traced back to the quality of the cure. A heat blanket or sensing system provides temperature uniformity over the entire surface and is a key step in expediting the repair process to achieve a higher quality result. To conduct a repair, care needs to be taken to properly heat and insulate the area both before and during the repair and is very time consuming and costly. Because the fuselage is not one thickness throughout, the repair experiences hot and cold spots within the fuselage during the repair and can result in a bad repair with delamination and/or porosity.

To save costs, a new heating system has been developed utilizing high power infrared (IR) lamps that can localize the heat and provide higher temperatures to an individual location on irregular parts. However, there is currently no way to accurately monitor temperature in that area or section that would show localized heat distribution throughout this heated area under the lamp. The current thermocouples measure only discrete points near the repair area and could result in additional finishing process if the thermocouples are placed too close to or too far from the repair area due to thermocouple markoff.

A system to accurately monitor the temperature on the composite repair section to show localized heat distribution throughout the heated area under the heat blanket or sensing system through multipoint or multizone temperature measurement and profiling of temperature on a complex composite structure where cold and hot areas (high and low thermal mass, respectively) might be present would be beneficial.

### BRIEF SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Aspects of this disclosure may relate to a system for temperature profiling and monitoring for use on a composite repair section. The system may comprise an array of imbedded temperature sensors bonded between two fluorinated ethylene propylene (FEP) films and an x-y grid pattern. The x-y grid pattern may include a plurality of square grids of the array of the imbedded temperature sensors. Each square grid may include at least one of the imbedded temperature sensors. Additionally, the array of imbedded temperature sensors may provide a complete temperature profile of the composite repair section and increase a temperature uniformity on the composite repair section. Furthermore, the array of the imbedded temperature sensors may be: an array of imbedded distributed fiber optic temperature sensors, an array of imbedded thin profile thermocouples, or an array of imbedded printed thermocouple circuits on a plurality of thermo pads. The x-y grid pattern may include square grids that are approximately 10 inches by 10 inches. The array of imbedded temperature sensors bonded between two FEP films may be approximately 0.063 inches thick. The system for temperature profiling and monitoring for use on a composite repair section may further comprise a software for temperature and composite mapping to generate the temperature profile and identify any hot spots and cold spots within an area of the composite repair section. Additionally, the system for temperature profiling and monitoring may be located over a caul plate and under a heat blanket for a repair section on an area of the composite repair section or located below a caul plate for a repair section on an area of the composite repair section. Lastly, the composite repair section may be an aerostructure fuselage.

Other aspects of this disclosure may relate to a system for repairing a composite structure section. The system may comprise a repair section on a composite structure section that includes a plurality of layers, a vacuum bag surrounding the repair section and the plurality of layers, a vacuum bag sealant tape to attach the vacuum bag to the composite structure section, and a multipoint temperature profile and monitoring system. The vacuum bag may include one or more vacuum ports. The plurality of layers may include a repair patch, a peel ply layer, a release film, a bleeder layer, a breather layer, a caul plate, and a heat blanket. The multipoint temperature profile and monitoring system may include an array of imbedded temperature sensors bonded between two fluorinated ethylene propylene (FEP) films and an x-y grid pattern that includes a plurality of square grids of the array of the imbedded temperature sensors. Each square grid may include at least one of the imbedded temperature sensors. The array of imbedded temperature sensors may provide a complete temperature profile of the composite repair and increase a temperature uniformity on the composite repair. Furthermore, the array of the imbedded temperature sensors may be: an array of imbedded distributed fiber optic temperature sensors, an array of imbedded thin profile thermocouples, or an array of imbedded printed thermocouple circuits on a plurality of thermo pads. Furthermore, the repair section may include a second release film located above the bleeder layer and below the breather layer, a second breather layer located above the caul plate and below the heat blanket, and a third breather layer located above the heat blanket. The multipoint temperature profile and monitoring system may be located over the caul plate and under the heat blanket within the repair section or located below the caul plate within the repair section. The composite structure section may be an aerostructure fuselage.

### BRIEF DESCRIPTION OF THE DRAWINGS

The present invention is illustrated by way of example and not limited in the accompanying figures in which like reference numerals indicate similar elements and in which:

FIG. 1A illustrates an example aerostructure or fuselage for repair, according to one or more aspects described herein;

FIG. 1B illustrates a sample cross-sectional view of the example aerostructure or fuselage for repair as illustrated in FIG. 1A, according to one or more aspects described herein;

FIG. 2 illustrates an example of a repair section and a sensing system for a fuselage repair, according to one or more aspects described herein;

FIG. 3 illustrates an example temperature profile for the sensing system, according to one or more aspects described herein; and

FIG. 4 illustrates an example multipoint temperature profile and monitoring system, according to one or more aspects described herein.

Further, it is to be understood that the drawings may represent the scale of different components of one single embodiment; however, the disclosed embodiments are not limited to that particular scale.

### DETAILED DESCRIPTION

In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention. Also, while the terms “top,” “bottom,” “front,” “back,” “side,” “rear,” and the like may be used in this specification to describe various example features and elements of the invention, these terms are used herein as a matter of convenience, e.g., based on the example orientations shown in the figures or the orientation during typical use. Nothing in this specification should be construed as requiring a specific three dimensional orientation of structures in order to fall within the scope of this invention. Also, the reader is advised that the attached drawings are not necessarily drawn to scale.

In the following description of the various embodiments, reference is made to the accompanying drawings, which form a part hereof, and in which is shown, by way of illustration, various embodiments in which aspects of the disclosure may be practiced. It is to be understood that other embodiments may be utilized and structural and functional modifications may be made without departing from the scope and spirit of the present disclosure.

The present invention is a sensing system that will accurately monitor cold and hot spots and verify the appropriate area temperature where infrared LED (IR LED) is being activated. The sensing system may also be referred to as a smart blanket. Various embodiments of this invention may be provided as solutions, which may include: miniaturized thermocouples that can be embedded into the sensing system, distributed temperature sensing (DTS) system and software for heat modeling, and/or printed thermocouple circuits on thermo pads. The sensing system may be a grid of sensors that is either a standalone layer, such as a sheet or blanket, or integrated with any of the layers already common in composite repair, i.e. printed circuitry or over-molded circuitry. One or more of these solutions may be utilized alone or in combination. These solutions will dramatically reduce time and cost of properly setting up heading and insulation systems currently used today. These solutions will also increase the accuracy and efficiency of temperature monitoring to reduce errors and downtime due to errors.

Additionally, the invention provides an easier way to generate the temperature profile of a heated area during a fuselage repair by pin-pointing and identifying hot and cold problem areas on a complex fuselage section. The invention further allows end users to control heat delivery to the cold spots and reduce heat to areas that are in elevated temperature zones with the fuselage repair heating system. In addition to ensuring uniform temperature on the repair throughout the complex fuselage part/section, the end user can also receive the benefit of reduced energy expenditure by controlling energy draw to where the energy/heat is needed and the cost savings in process insulation methods and set up.

This invention is a design of a temperature measurement product and a manufacturing process of such invention. The purpose of the invention is for multipoint and/or multizone measurement and profiling of temperature on a complex composite structure where cold and hot areas might be present. This invention provides users with a complete temperature profile of a repair section of a composite aerostucture, such as a fuselage. Rather than looking at the repair from a few temperature points taken with discrete thermocouples, embodiments of the invention provides a full grid view of on part and heating system temperature profile. The ability to control hot and cold spots within the repair section and increase temperature uniformity on the repair section will ensure a defect free, completely cured, and bonded repair on the aerostructure or fuselage. Additionally, multiple repairs or thermal surveys may result in damage to areas of the part not requiring repair. The sensing system of the present invention accurately measures heat distribution both on and off the repair area which may allow for a heating device to more efficiently focus thermal energy. This sensing system will result in a decrease in scrapped or re-repaired parts.

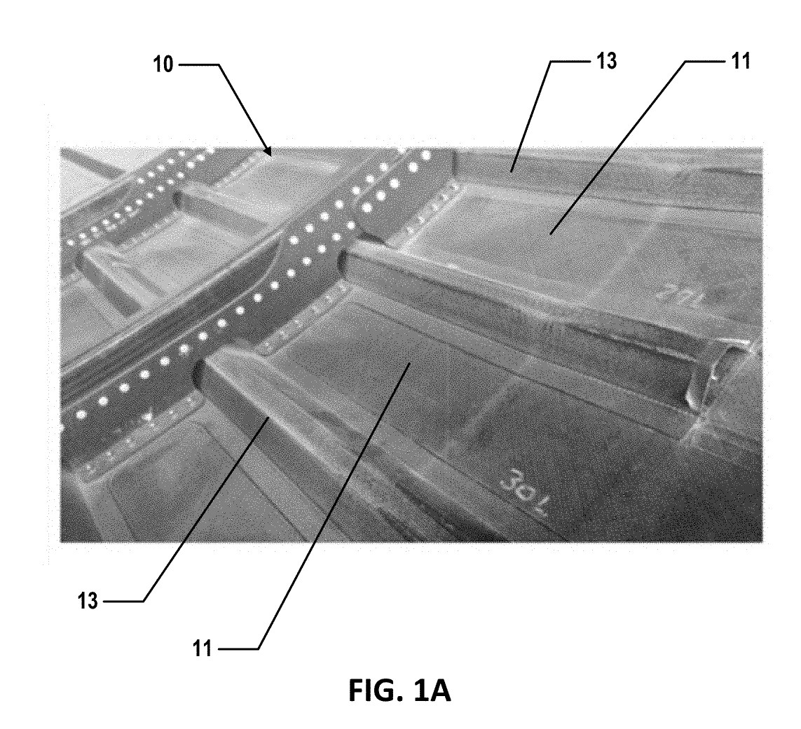

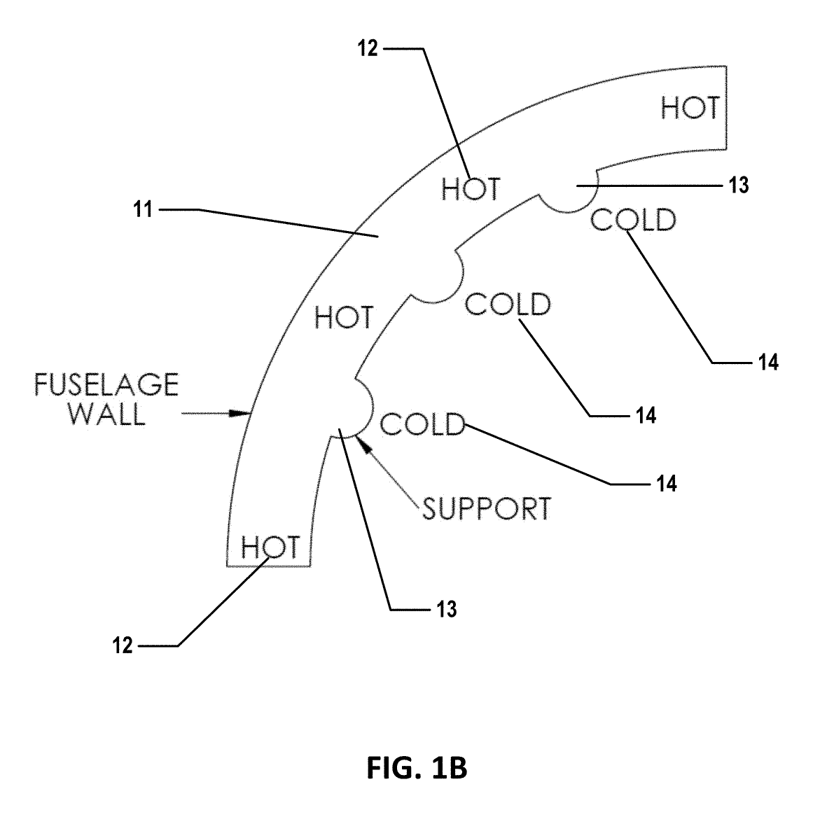

FIG. 1A illustrates an example aerostructure or fuselage 10 for repair. FIG. 1B illustrates a sample cross-sectional view of the example aerostructure or fuselage 10 for repair. The fuselage 10 includes both a fuselage wall 11 and fuselage supports 13. As illustrated in FIG. 1B, the fuselage 10 may include various hot sections 12 and cold sections 14 throughout the cross-sectional area. Generally, the hot sections 12 are located along the fuselage wall 11 and the cold sections 14 are located along the fuselage support 13 for the fuselage wall 11.

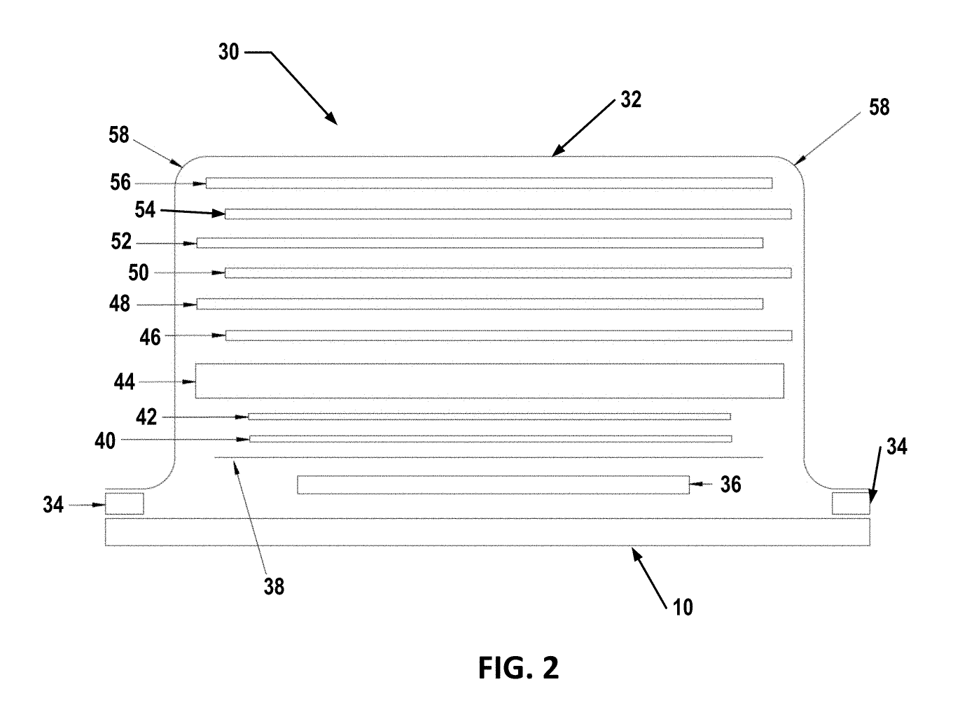

FIG. 2 illustrates an example of a repair section 30 for a fuselage 10 repair. As illustrated in FIG. 2, the repair section 30 may include a vacuum bag 32. The vacuum bag 32 may include vacuum bag sealant tape 34 to attach the vacuum bag 32 to the fuselage 10. The repair section 30 may also include various layers on the fuselage 10 within the vacuum bag 32. In an example repair, the repair section 30 closest to the fuselage 10 may include a patch 36, a temperature sensing layer 38, a peel ply 40, a first release film 42, a bleeder layer 44, a second release film 46, a first breather layer 48, a caul plate 50, a second breather layer 52, a heat blanket 54, and a third breather layer 56. Additionally, the vacuum bag 32 may include one or more vacuum ports 58 adjacent to the third breather layer 56. Other layers may be utilized for the repair section 30 without departing from this invention. Additionally, the order for the layers for the repair section 30 may be different without departing from this invention.

In another example repair, the repair section 30 closest to the fuselage 10 may include a peel ply, a release film, a bleeder, a breather, a caul plate, a heat blanket, a bagging film, a sealant tape and then miscellaneous thermocouples, insulation and/or process controllers.

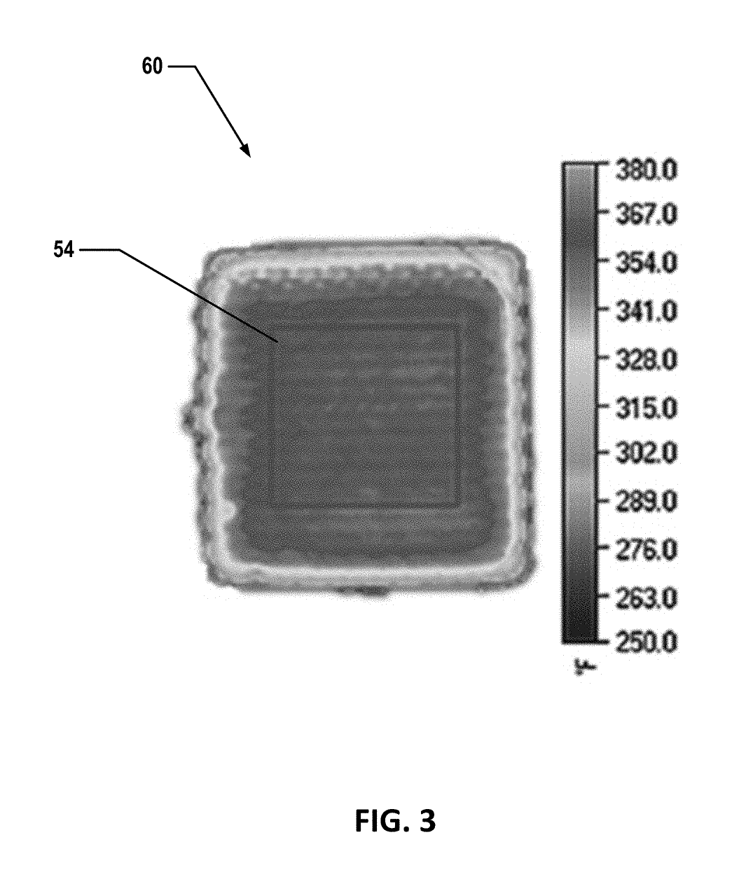

FIG. 3 illustrates an example temperature profile 60 for the heat blanket 54. As illustrated in FIG. 3, the heat blanket temperature profile 60 shows a heat distribution with higher heat in the middle or center of the heat blanket 54 and cooler heat on the edges or outside of the heat blanket 54.

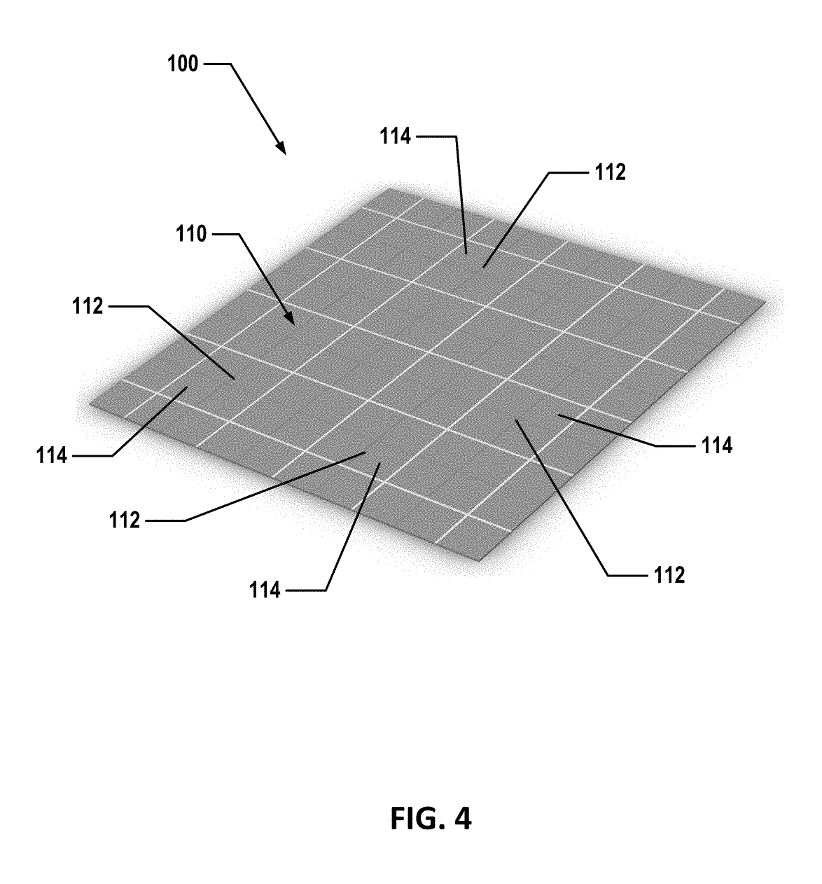

FIG. 4 illustrates an example multipoint and/or multizone temperature profile and monitoring system 100 in accordance with aspects of this invention. The multipoint temperature profile and monitoring system 100 provides users with a complete temperature profile of a repair section 30 of a composite aerostucture 10. Rather than looking at the repair 30 from a few temperature points taken with discrete thermocouples, the multipoint temperature profile and monitoring system 100 provides a full grid view of on-part and heating system temperature profile. The ability to control hot spots 12 and cold spots 14 within the repair section 30 and increase temperature uniformity on the repair section 30 will ensure a defect free, completely cured, and bonded repair on the fuselage 10 or aerostructure.

The multipoint temperature profiling and monitoring system 100 may be a thin pad or sensing system 110 that contains a plurality of imbedded temperature sensing devices 112. The plurality of imbedded temperature sensing devices 112 may include one of the following: imbedded distributed fiber optic temperature sensors, thin profile AccuFlex thermocouples, printed thermocouple circuits, or thermistors. The sensing system 110 can be used in combination with resistance wire heat blankets or with other means of heat delivered over the repair area 30. The sensing system 110 can be applied and placed between or within any of the layers demonstrated in FIG. 2 with the purpose of monitoring heat transfer between those layers.

Referring to both FIGS. 2 and 4, the sensing system 110 may be placed over the caul plate 50 and under the heat blanket 54. The advantage of the sensing system 110 is that the sensing system 110 will eliminate the risk of thermocouple mark off. In another embodiment, the sensing system 110 may be placed below the caul plate 50. The sensing system 110 may measure the output of the heat blanket 54. The sensing system 110 may also be positioned on the reverse side of the repair section 30, if access is available. The sensing system 110 may be re-usable to allow further cost savings.

As illustrated in FIG. 4, the multipoint temperature profiling and monitoring system 100 may include a sensing system 110 with an array of imbedded distributed fiber optic temperature sensors 112. The fiber optic temperature sensors 112 may be bonded between two thin fluorinated ethylene propylene (FEP) films 114. The bonded fiber optic temperature sensors 112 and the two thin fluorinated ethylene propylene (FEP) films 114 may have an approximate thickness of 0.063 inches. Other films 114 may be utilized to bond the fiber optic temperature sensors 112 for the sensing system 110.

As further illustrated in FIG. 4, the sensing system 110 includes an x-y grid pattern with the array of the imbedded distributed fiber optic temperature sensors 112. The sensing system 110 as illustrated in FIG. 4 may be a grid pattern with 10 inches by 10 inches grid size. Other grid sizes and thicknesses may be utilized for the sensing system 110 without departing from this invention depending on the method of manufacture and the area of sensing required. Each x-y grid may have its own imbedded distributed fiber optic temperature sensors 112. The x-y grid pattern array of imbedded distributed fiber optic temperature sensors 112 allows the sensing system 110 to be utilized for various shapes and sizes of composite materials. Software temperature and composite mapping may be also utilized with the sensing system 110 without departing from this invention.

Alternatively, instead of utilizing an array of imbedded distributed fiber optic temperature sensors 112, the sensing system 110 may utilize an array of thin profile thermocouples or a printed thermocouple circuit.

While the invention has been described in detail in terms of specific examples including presently preferred modes of carrying out the invention, those skilled in the art will appreciate that there are numerous variations and permutations of the above described systems and methods. Thus, the spirit and scope of the invention should be construed broadly as set forth in the appended claims.

We claim:

1. A system for temperature profiling and monitoring for use on a composite repair section, the system comprising:
an array of imbedded temperature sensors bonded between two fluorinated ethylene propylene (FEP) films; and
an x-y grid pattern that includes a plurality of square grids of the array of the imbedded temperature sensors, wherein each square grid includes at least one of the imbedded temperature sensors, and further wherein the array of imbedded temperature sensors provide a complete temperature profile of the composite repair section and increase a temperature uniformity on the composite repair section.

2. The system from claim 1, wherein the array of the imbedded temperature sensors are an array of imbedded distributed fiber optic temperature sensors.

3. The system from claim 1, wherein the array of the imbedded temperature sensors are an array of imbedded thin profile thermocouples.

4. The system from claim 1, wherein the array of the imbedded temperature sensors are an array of imbedded printed thermocouple circuits on a plurality of thermo pads.

5. The system from claim 1, wherein the x-y grid pattern includes square grids that are approximately 10 inches by 10 inches.

6. The system from claim 1, wherein the array of imbedded temperature sensors bonded between two FEP films is approximately 0.063 inches thick.

7. The system from claim 1 further comprising a software for temperature and composite mapping to generate the temperature profile and identify any hot spots and cold spots within an area of the composite repair section.

8. The system from claim 1, wherein the system for temperature profiling and monitoring is located over a caul plate and under a heat blanket for a repair section on an area of the composite repair section.

9. The system from claim 1, wherein the system for temperature profiling and monitoring is located below a caul plate for a repair section on an area of the composite repair section.

10. The system from claim 1, wherein the composite repair section is an aerostructure fuselage.

11. A system for repairing a composite structure section, the system comprising:
a repair section on a composite structure section that includes a plurality of layers, wherein the plurality of layers includes a repair patch, a peel ply layer, a release film, a bleeder layer, a breather layer, a caul plate, and a heat blanket;
a vacuum bag surrounding the repair section and the plurality of layers;
a vacuum bag sealant tape to attach the vacuum bag to the composite structure section; and
a multipoint temperature profile and monitoring system that includes:
an array of imbedded temperature sensors bonded between two fluorinated ethylene propylene (FEP) films; and
an x-y grid pattern that includes a plurality of square grids of the array of the imbedded temperature sensors, wherein each square grid includes at least one of the imbedded temperature sensors, and further wherein the array of imbedded temperature sensors provide a complete temperature profile of the composite repair and increase a temperature uniformity on the composite repair.

12. The system from claim 11, wherein the array of the imbedded temperature sensors are an array of imbedded distributed fiber optic temperature sensors.

13. The system from claim 11, wherein the array of the imbedded temperature sensors are an array of imbedded thin profile thermocouples.

14. The system from claim 11, wherein the array of the imbedded temperature sensors are an array of imbedded printed thermocouple circuits on a plurality of thermo pads.

15. The system from claim 11, the repair section further including a second release film located above the bleeder layer and below the breather layer.

16. The system from claim 11, the repair section further including a second breather layer located above the caul plate and below the heat blanket and a third breather layer located above the heat blanket.

17. The system from claim 11, wherein the multipoint temperature profile and monitoring system is located over the caul plate and under the heat blanket within the repair section.

18. The system from claim 11, wherein the multipoint temperature profile and monitoring system is located below the caul plate within the repair section.

19. The system from claim 11, wherein the composite structure section is an aerostructure fuselage.

20. The system from claim 11, wherein the vacuum bag includes one or more vacuum ports.
